(19) United States
(12) Patent Application Publication
(10) Pub. No.: US 2014/0115905 A1
(43) Pub. Date: May 1, 2014

(54) Kind of chain saw

(71) Applicant: Huanzhong HAN, Zhejiang (CN)

(72) Inventor: Huanzhong HAN, Zhejiang (CN)

(21) Appl. No.: 14/054,840

(22) Filed: Oct. 16, 2013

(30) Foreign Application Priority Data
Oct. 26, 2012 (CN) 201220552522.9

(51) Int. Cl. B27B 17/02

(52) U.S. Cl. CPC B27B 17/02
USPC 30/378

(57) ABSTRACT

A chain saw comprising a main body, a shell, a motor, a motor output shaft, a cutting element, a supporting plate and a handle; the shell is provided on the main body; the motor is mounted inside the shell; the motor output shaft is used for driving the cutting element to rotate; the handle is mounted to a rear end of the main body via a connection tube; the chain saw also comprises a lever rod on the main body; the lever rod is movably connected to an upper protection panel and a lower protection panel both disposed on a front end of the main body; the supporting plate is fixedly connected to the front end of the main body and accommodated between the upper protection panel and the lower protection panel; the lever rod and the lower protection panel are connected with each other via a connection mechanism.

### BACKGROUND OF THE INVENTION

The present invention relates to a kind of power tool, and more specifically relates to a kind of chain saw with rotatable handle.

Nowadays, there are various kinds of tools for pruning plants in the market, for example there are pruners for pruning relatively smaller branches and leaves and there are hedge trimmers and chain saws generally used for pruning relatively thicker woods. Due to continuous development in greening and hence more demanding requirements for greening works, chain saw becomes a kind of indispensable greening tool. Chinese invention patent application of number 200910137817.2 discloses a kind of chain saw which mainly comprises a cutting element, a supporting plate, a motor, a motor shell, a guide mechanism, a handle device and a connection mechanism, wherein the supporting plate provided with a supporting plate plane is used for supporting the cutting element, and can pivotally rotate around a fixed axis in the supporting plate plane; the motor is provided with a motor output shaft to drive the cutting element to rotate; the motor shell is used for accommodating the motor; the guide mechanism is connected with the motor shell; the guide mechanism is provided with a longitudinal extending axis; the handle device does linear motion operatively along the longitudinal extending axis of the guide mechanism; the handle device is connected with the supporting plate via the connection mechanism; and the connection mechanism converts the linear motion of the handle device into the pivotal rotation of the supporting plate. The chain saw as disclosed above has the following disadvantages: 1. Since the handle device does linear motion, an amount of force sufficient to cut thick woods must be applied during use, and due to a considerable amount of force which must be applied, users may feel very tired after a long period of use; 2. Since the handle device cannot rotate, horizontal cutting of woods may seem easier and effort-saving but vertical cutting of woods may in turn be effort-draining. In view of the above, chain saws currently available in the market have to be improved.

### BRIEF SUMMARY OF THE INVENTION

In view of the aforesaid disadvantages now present in the prior art, the present invention provides a kind of chain saw which has a reasonably designed structure. The chain saw according to the present invention is comfortable to operate and has a rotatable handle.

The present invention adopts the following technical proposal:

A kind of chain saw comprising a main body, a shell, a motor, a motor output shaft, a cutting element, a supporting plate for supporting the cutting element, and a handle; the shell is provided on the main body; the motor is mounted inside the shell; the motor output shaft is used for driving the cutting element to rotate; the handle is mounted to a rear end of the main body via a connection tube; the chain saw also comprises a lever rod on the main body; the lever rod is movably connected to an upper protection panel and a lower protection panel both disposed on a front end of the main body; the supporting plate is fixedly connected to the front end of the main body and accommodated between the upper protection panel and the lower protection panel; the lever rod and the lower protection panel are connected with each other via a connection mechanism; the connection mechanism converts pulling of the lever rod to pivotal rotation of the lower protection panel; the connection mechanism comprises a driving element, a connection rod and a driven element; the driving element is supported by the lever rod; the driven element is fixedly connected to the lower protection panel; the connection rod is disposed between the driving element and the driven element, and connected with the driving element and the driven element respectively by means of hinge connection.

The driven element is a rotatable base; one side of the rotatable base is connected with the connection rod by means of hinge connection, another side of the rotatable base is fixedly connected with the lower protection panel.

The chain saw further comprises a motion transmission mechanism; the motion transmission mechanism is disposed between the motor output shaft and the cutting element; the motion transmission mechanism enables the motor output shaft to drive and rotate the cutting element via meshing of gears.

The handle is rotatably disposed at the rear end of the main body.

The upper protection panel is movably connected to the front end of the main body via a torsion spring.

Compared with the prior art, the present invention has the following advantages:

1. The supporting plate of the present invention is fixedly and non-movably connected to the front end of the main body; during use, when the lever rod is pulled, the lower protection panel will pivotally rotate and open, and the lower protection panel will then reset its position upwardly due to restoring force and hence exert force to the object to be cut. Accordingly, cutting becomes more effort-saving and users will not feel tired easily even after a long period of use.

2. The handle is rotatable. Accordingly, effort can be saved regardless of different cutting directions. The chain saw is therefore every comfortable to use.

### BRIEF DESCRIPTION OF THE DRAWINGS

FIG. 1 is a structural view of the present invention.

FIG. 2 illustrates a sectional view of the present invention with the lower protection panel being opened.

FIG. 3 illustrates a sectional view of the present invention showing the motion transmission mechanism between the motor output shaft and the cutting element.

FIG. 4 is another structural view of the present invention after the handle is being turned 90 degrees.

### DETAILED DESCRIPTION OF THE INVENTION

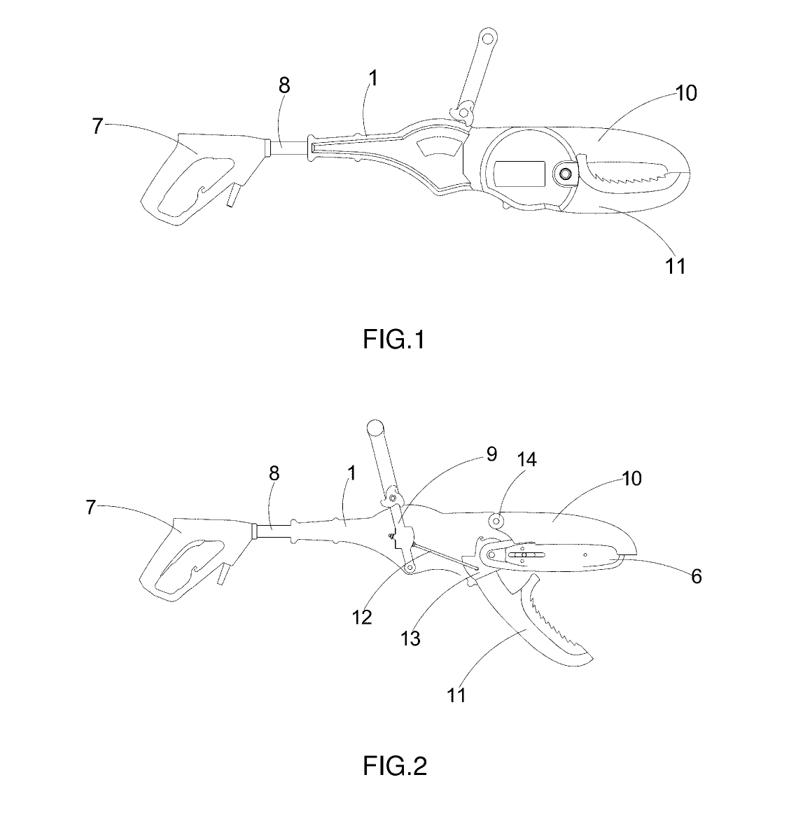

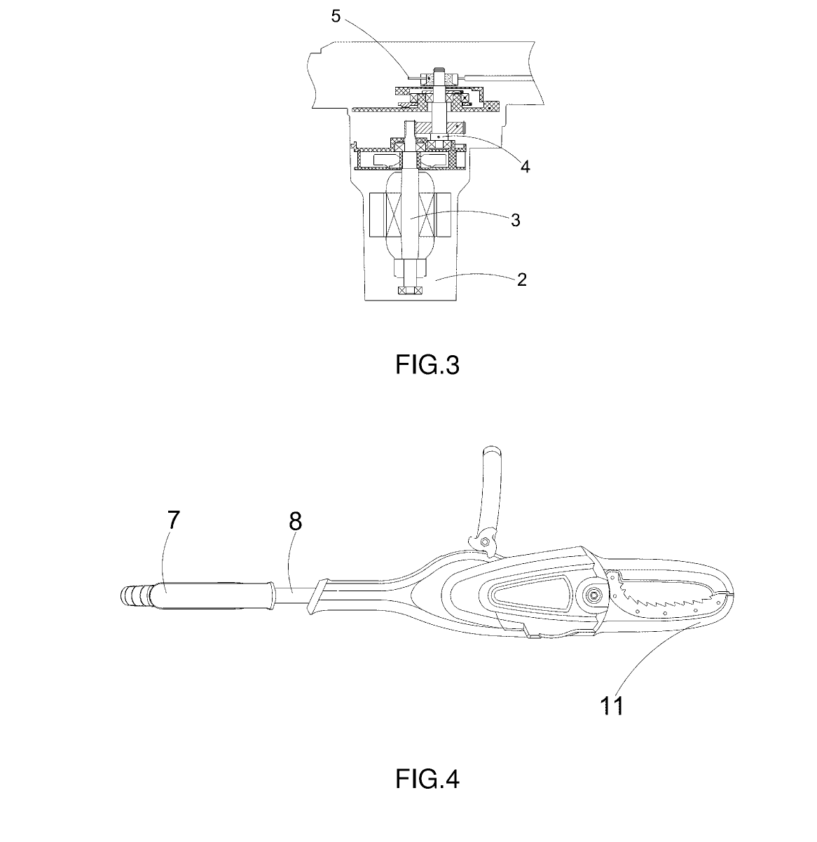

As shown in FIG. 1 to FIG. 4, the chain saw of the present invention comprises a main body 1, a shell 2, a motor 3, a motor output shaft 4, a cutting element 5, a supporting plate 6 for supporting the cutting element 5, and a handle 7. The shell 2 is provided on the main body 1; the motor 3 is mounted inside the shell 2; the motor output shaft 4 is used for driving the cutting element 5 to rotate; the handle 7 is mounted to a rear end of the main body 1 via a connection tube 8; the chain saw of the present invention also comprises a lever rod 9 on the main body 1; the lever rod 9 is movably connected to an upper protection panel 10 and a lower protection panel 11 both disposed on a front end of the main body 1; the supporting plate 6 is fixedly connected to the front end of the main body 1 and accommodated between the upper protection panel 10 and the lower protection panel 11; the lever rod 9 and the lower protection panel 11 are connected with each other via a connection mechanism; the connection mechanism converts pulling of the lever rod 9 to pivotal rotation of the lower protection panel 11; the connection mechanism comprises a driving element, a connection rod 12 and a driven element; the driving element is supported by the lever rod 9; the driven element is fixedly connected to the lower protection panel 11; the connection rod 12 is disposed between the driving element and the driven element, and connected with the driving element and the driven element respectively by means of hinge connection; the driven element is a rotatable base 13; one side of the rotatable base 13 is connected with the connection rod 12 by means of hinge connection, another side of the rotatable base 13 is fixedly connected with the lower protection panel 11; the chain saw of the present invention further comprises a motion transmission mechanism; the motion transmission mechanism is disposed between the motor output shaft 4 and the cutting element 5; the motion transmission mechanism enables the motor output shaft 4 to drive and rotate the cutting element 5 via meshing of gears; the handle 7 is rotatably disposed at the rear end of the main body 1 for easier cutting of vertical raw wood; the upper protection panel 10 is movably connected to the front end of the main body 1 via a torsion spring 14.

What is claimed is:

1. A chain saw comprising a main body, a shell, a motor, a motor output shaft, a cutting element, a supporting plate for supporting the cutting element, and a handle; the shell is provided on the main body; the motor is mounted inside the shell; the motor output shaft is used for driving the cutting element to rotate; the handle is mounted to a rear end of the main body via a connection tube; the chain saw also comprises a lever rod on the main body; the lever rod is movably connected to an upper protection panel and a lower protection panel both disposed on a front end of the main body; the supporting plate is fixedly connected to the front end of the main body and accommodated between the upper protection panel and the lower protection panel; the lever rod and the lower protection panel are connected with each other via a connection mechanism; the connection mechanism converts pulling of the lever rod to pivotal rotation of the lower protection panel; the chain saw is characterized in that, the connection mechanism comprises a driving element, a connection rod and a driven element; the driving element is supported by the lever rod; the driven element is fixedly connected to the lower protection panel; the connection rod is disposed between the driving element and the driven element, and connected with the driving element and the driven element respectively by means of hinge connection.

2. The chain saw as in claim 1, wherein the driven element is a rotatable base; one side of the rotatable base is connected with the connection rod by means of hinge connection, another side of the rotatable base is fixedly connected with the lower protection panel.

3. The chain saw as in claim 1, wherein the chain saw further comprises a motion transmission mechanism; the motion transmission mechanism is disposed between the motor output shaft and the cutting element; the motion transmission mechanism enables the motor output shaft to drive and rotate the cutting element via meshing of gears.

4. The chain saw as in claim 1, wherein the handle is rotatably disposed at the rear end of the main body.

5. The chain saw as in claim 1, wherein the upper protection panel is movably connected to the front end of the main body via a torsion spring.
